(19) United States
(12) Patent Application Publication
(10) Pub. No.: US 2002/0092216 A1
(43) Pub. Date: Jul. 18, 2002

(54) Recreational vehicle (RV) license plate frame

(76) Inventor: Thomas V. Rice, Boise, ID (US)

Correspondence Address: Ken J. Pedersen, Pedersen & Company, PLLC, P.O. Box 2666, Boise, ID, 83701-2666, US

(21) Appl. No.: 09/760,409

(22) Filed: Jan. 12, 2001

(51) Int. Cl. G09F 7/00

(52) U.S. Cl. 40/209; 40/210

(57) ABSTRACT

The present invention is an RV license plate frame which has an integral holder for an RV sticker. In a preferred embodiment, the RV sticker holder is a horizontal, clear plastic cylinder removably enclosed in a housing which is connected to the license plate frame. To use, the RV owner removes the plastic cylinder from the housing, and inserts the RV sticker into the plastic cylinder with the display surface of the RV sticker showing outwardly through the clear plastic. Then, the owner replaces the plastic cylinder within its housing on the license plate frame. This way, there is provided an effective and economical means for displaying an RV sticker and vehicle license plate at the same time.

### BACKGROUND OF THE INVENTION

1. Field of the Invention

This invention pertains generally to vehicles, and more specifically, to license plate frames for recreational vehicles (RVs). This invention is a convenient holder for an RV sticker which is built into the RV's license plate frame.

2. Related Art

In most States of the U.S.A., recreational vehicles (RVs-namely motor homes, trailers, campers, boats, all terrain vehicles (ATVs), snowmobiles and off-road motorcycles, etc.) require a permit sticker issued by the State. Typically, the sticker must be affixed to and displayed from the RV. In addition, many RV's are also “street-ready” and therefore also require a vehicle license plate which also must be affixed to and displayed from the RV. Therefore, an RV must often display both the license plate and the RV sticker.

Typically, this multiple RV license/sticker display has been accomplished by the RV owner simply affixing the RV sticker by its adhesive to the RV body. However, there are drawbacks to this approach. For example, year after year an older RV may become substantially covered by the RV stickers, which is not an attractive sight. Or, the owner may simply run out of room to place a new RV sticker on an older RV, especially when the body of the RV is relatively small, as in the case of off-road motorcycles. Also, the RV body may not be well suited for receiving the RV stickers. For example, the RV body may not be smooth enough, or clean enough, to accept the adhesive for the RV sticker. Furthermore, there is rarely enough room on the display surface of the RV license plate for it to receive and display also the RV sticker.

So, there is still a need for an effective and economical means for displaying an RV sticker and vehicle license plate at the same time. This invention addresses that need.

### SUMMARY OF THE INVENTION

The present invention is an RV license plate frame which has an integral holder for an RV sticker. The RV sticker holder is built into the license plate frame. In a preferred embodiment, the RV sticker holder is a horizontal, clear plastic cylinder removably enclosed in a housing which is connected to the license plate frame. The clear cylinder is sized so that it is larger in diameter than the standard-sized RV sticker when the sticker is curled into a cylinder around its longest axes. Also, the clear cylinder is slightly longer than the longest side of the standard-sized RV sticker. To use this preferred embodiment, the RV owner removes the plastic cylinder from the housing, and inserts the whole RV sticker, with the backing over the adhesive still intact, into the plastic cylinder with the display surface of the RV sticker showing outwardly through the clear plastic. Then, the owner replaces the plastic cylinder within its housing on the license plate frame. This way, there is provided an effective and economical means for displaying an RV sticker and vehicle license plate at the same time.

### BRIEF DESCRIPTION OF THE DRAWINGS

FIG. 1 is a side, perspective view of one embodiment of the invention.

FIG. 2 is a front view of the embodiment depicted in FIG. 1.

FIG. 3 is a front view of an alternative embodiment of the invention.

FIG. 4 is a side view of the embodiment depicted in FIGS. 1 and 2.

FIG. 5 is a side view of an alternative embodiment of the invention.

### DESCRIPTION OF THE PREFERRED EMBODIMENTS

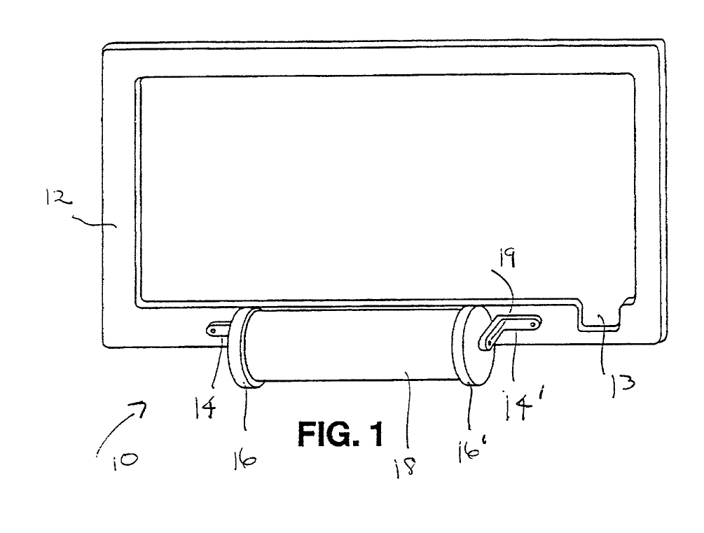

Referring to the Figures, there are depicted several, but not all, embodiments of the present invention. FIG. 1 is a side perspective view of one embodiment 10 of the invention, for example, for a motor home. The RV license plate frame 10 of the invention has conventional license plate frame 12, with optional lower right hand corner cut-out 13 for leaving the vehicle's annual license plate sticker visible. Brackets 14, 14′ are connected to frame 12 for supporting housing portions 16, 16′. Supported between housing portions 16, 16′ is horizontal, clear plastic cylinder 18.

Cylinder 18 is removable from housing portions 16, 16′. In the case of FIG. 1, screw 19 may be removed between housing portion 16′ and bracket 14′. This way, housing portion 16′ may be removed, and cylinder 18 tipped out and away from remaining housing portion 16, due to the flexibility in bracket 14 or plate frame 12. When cylinder 18 is removed from housing portion 16, an RV sticker may be curled up inside cylinder 18 with the sticker's display surface showing outwardly through the clear plastic. Then, the owner replaces plastic cylinder 18 with the RV sticker inside within first housing portion 16, and replaces second housing portion 16′ and screw 19.

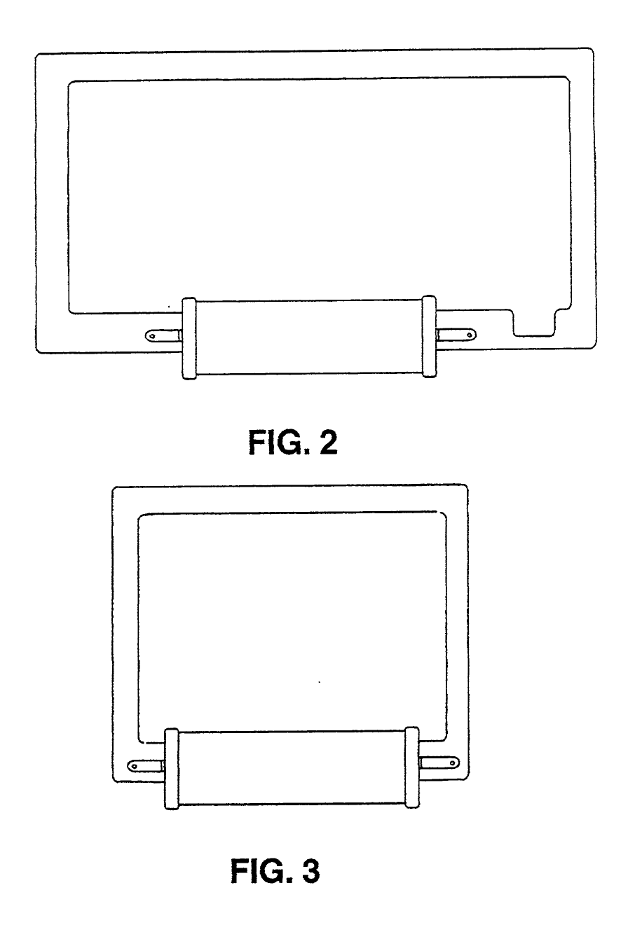

FIG. 2 is a front view of the embodiment depicted in FIG. 1. FIG. 3 is a front view of an alternative embodiment of the invention, for example, for a motorcycle.

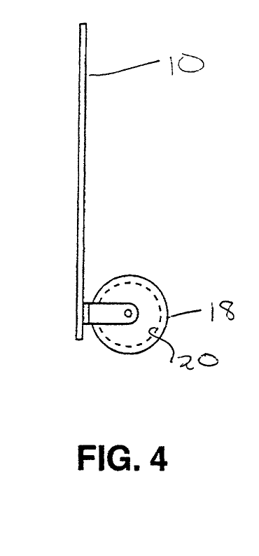

In FIG. 4 is depicted an embodiment of the invention 10 with RV sticker 20 rolled up inside plastic cylinder 18. This way, there is provided an effective and economical means for displaying an RV sticker and vehicle license plate at the same time.

In a different, molded embodiment brackets 14, 14′ and housing 16, 16′ may be integral, smoothly contoured portions built into frame 12. Also, cylinder 18 with a suitable transparent portion may also be integral with housing 16, 16′. Also, cylinder 18 may be squared off on its back end, so that less distance from the front of frame 12 is necessary to accommodate the sticker holder. Also, screw 19 may pass all the way through between housing portions 16, 16′ for reinforcement of the sticker holder. The sticker holder is preferably available in black, gold, chrome and white colors, at least.

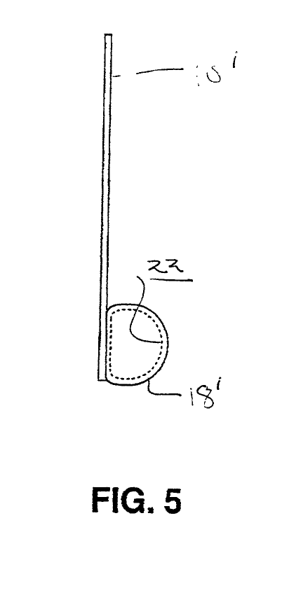

In FIG. 5 is depicted an embodiment of the invention 10′ with a horizontal D-shaped member 18′ extending along its lower edge with its flat side connected to the license plate frame. D-shaped member 18′ has recessed surface 22 upon which the RV sticker may be mounted.

Although this invention has been described above with reference to particular means, materials and embodiments, it is to be understood that the invention is not limited to these disclosed particulars, but extends instead to all equivalents within the scope of the following claims.

I claim:

1. An RV license plate frame with an additional sticker holder, comprising:
a vehicle license plate frame;
a bracket connected to said plate frame; and
an additional surface supported by said bracket, said additional surface being adapted to receive a vehicle sticker separately from a vehicle license plate.

2. The license plate frame of claim 1 wherein the additional surface is the inside surface of a hollow cylinder with a transparent portion.

3. An RV license plate frame with an additional sticker holder, comprising:
a vehicle license plate frame; and,
a horizontal member extending along an edge of said license plate frame, said horizontal member providing an additional surface upon which an RV sticker may be mounted separately from a vehicle license plate.

4. The license plate frame of claim 3 wherein the additional surface is the outside surface of said horizontal member.

5. The license plate frame of claim 3 wherein said horizontal member is a D-shaped member with its flat side connected to the license plate frame.
